(19) United States
(12) Patent Application Publication
(10) Pub. No.: US 2010/0280992 A1
(43) Pub. Date: Nov. 4, 2010

(54) System and Method for Photo-image Uplink Confirmation

(76) Inventors: Dimitry Vaysburg, Livermore, CA (US); Prodyut Hazarika, Mountain View, CA (US); Tushar Tyagi, Sunnyvale, CA (US)

Correspondence Address: LAW OFFICE OF GERALD MALISZEWSKI, P.O. BOX 270829, SAN DIEGO, CA, 92198-2829, US

(21) Appl. No.: 12/432,625

(22) Filed: Apr. 29, 2009

Related U.S. Application Data
(63) Continuation-in-part of application No. 12/431,914, filed on Apr. 29, 2009.
Application No. 12/431,914 is a continuation-in-part of application No. 12/432,559, filed on Apr. 29, 2009.

(51) Int. Cl. G06F 17/30

(52) U.S. Cl. 707/634; 709/217; 707/E17.108; 707/E17.019; 707/E17.006

(57) ABSTRACT

A system and method are provided for automatic photo-image uplink confirmation. A photo-image discovery device scans communication interfaces for photo-capable devices, and determines if detected photo-capable devices have stored electronically formatted photo-images. The photo-images are acquired into the photo-image discovery device and uploaded to a network-connected storage site. A log is generated chronicling the photo-image upload status. The log is automatically supplied to the photo-capable device sourcing the photo-images, or to a discovery device user interface. In one aspect, the log is supplied in a photo-image file format (e.g., JPEG) for display of a user interface display of the photo-capable device.

### RELATED APPLICATIONS

This application is a Continuation-in-Part of a pending application entitled, SYSTEM AND METHOD FOR VIRTUAL KIOSK STORED PHOTO-IMAGE REPRODUCTION, invented by Vaysburg et al., Ser. No. 12/431,914, filed Apr. 29, 2009, attorney docket no. applied_{—}332;

which is a Continuation-in-Part of a pending application entitled, SYSTEM AND METHOD FOR PHOTO-IMAGE DISCOVERY AND STORAGE, invented by Vaysburg et al., Ser. No. 12/432,559, filed Apr. 29, 2009, attorney docket no. applied_{—}330. Both these disclosures are incorporated herein by reference.

### BACKGROUND OF THE INVENTION

1. Field of the Invention

This invention generally relates to electronic image storage and more particularly to a system and method for photo-image management, transformation, delivery, and uplink confirmation.

2. Description of the Related Art

Conventional technology permits a user to connect their camera or memory card to a personal computer (PC), open a software application in the PC, and upload images for local storage. Once the images are stored, the user may select images for local printing, organize folders, or create a CD. Further, the images may be uploaded to a network-connected storage site vendor, such as Costco. Once the images are uploaded, the user may select images for printing, and have the printed pictures prepared for pickup or delivery. Otherwise, the user can have the images archived.

Unfortunately, these operations are cumbersome and require extensive human interaction. Further, a minimal amount of technical acumen is required to perform these operations, and if the user is technophobic, the images may remain in the camera until they are lost, erased, or overwritten.

Eye-Fi™ is a wireless memory card that automatically uploads any images on the card, via a WiFi (IEEE 802.11) link, to a user's PC for local storage, or to a network-connected storage site. Unfortunately, the images remain on the memory card until the user comes within range of a WiFi access point (AP). The user cannot upload their images via a public AP unless the card has been previously preconfigured. Such an operation would require the use of a PC and a related software application. Due to the relatively long time it takes to upload a single image, the system is only practical for user who has a personal (home) WiFi AP. Further, while the automatic upload feature is a convenience, the user has lost all ability to edit and organize the images leaving the camera, and it is not necessarily easy to organize the images once they have been uploaded. Finally, neither the camera nor the memory card gives any indication of whether a link is available, the link bandwidth, the number of files uploaded, incorrect format issues, or the health and battery life of the camera. Therefore, user is unaware of which, if any, images have been successfully uploaded until they inventory their storage.

Conventionally, an end user who wants to print, order prints of their pictures, create albums, or personalize their photos, must use either a PC-driven software tool, or go to a store photo kiosk. The first option requires a working knowledge of PCs and a high-speed Internet connection. Alternately, if a user goes to the store, they must bring their SD card or USB key to select the pictures. This selection process can be lengthy and may require assistance from store personnel.

It would be advantageous if a feedback means existed to provide a user with an indication of whether a link was operational to support the uploading of images from a camera to a network-connected storage site.

It would be advantageous if a feedback means existed to provide a user with an indication of the images being uplinked from a camera to a network-connected storage site.

### SUMMARY OF THE INVENTION

A photo discovery system and method are disclosed herein that are capable of acquiring images from a variety of different sources, such as a digital camera, camcorder, 3G phone, cell phone, or personal computer (PC), and upload them into an Internet-connected storage/processing service. Once stored, the same photo discovery device can be used print, archive, or otherwise manage the images as a virtual kiosk, without the use of a personal computer (PC). The photo discovery device creates a log of interactions with the storage site, and provides the log to the user interface (UI) of the camera source supplying the images.

Accordingly, method is provided for automatic photo-image uplink confirmation. A photo-image discovery device scans communication interfaces for photo-capable devices, and determines if detected photo-capable devices have stored electronically formatted photo-images. The photo-images are acquired into the photo-image discovery device and uploaded to a network-connected storage site. A log is generated chronicling the photo-image upload status. In one aspect, the log is automatically supplied to the photo-capable device sourcing the photo-images. Typically, the log is supplied in a photo-image file format (e.g., JPEG) for display of a user interface display of the photo-capable device. Alternately, the log can be supplied via a user interface built into the discovery device, such as a speaker or LED display.

The log can be used to chronicle upload status information such as upload complete, the photo-image source, no uplink connection, uplink connection lost, photo-images rejected, photo-image file format converted, file formats rejected, image transformation operations, file format types uploaded, the number of photo-images uploaded, authentification requirements, and storage site unavailable. In one aspect, the method automatically supplies an acquisition report from the photo discovery device to the photo-image capable device sourcing the photo-images, chronicling the photo-image acquisition status.

Additional details of the above-described method and a photo-image discovery device a system for automatic photo-image uplink confirmation are provided below.

### BRIEF DESCRIPTION OF THE DRAWINGS

FIG. 1 is a schematic block diagram of a photo-image discovery device.

FIG. 2 is a diagram depicting a first exemplary image organization transaction.

FIG. 3 is a diagram depicting a second exemplary image organization transaction.

FIGS. 4A and 4B depict two exemplary processes for configuring the photo-image discovery device of FIG. 1.

FIG. 5 is a schematic block diagram of a virtual photo-image reproduction kiosk.

FIG. 6 is a schematic block diagram depicting a system for automatic photo-image uplink confirmation in a photo-image discovery device.

FIG. 7 is a diagram depicting the photo-image discovery device from a functional perspective.

FIG. 8 is a flowchart illustrating a method for automatic photo-image uplink confirmation.

### DETAILED DESCRIPTION

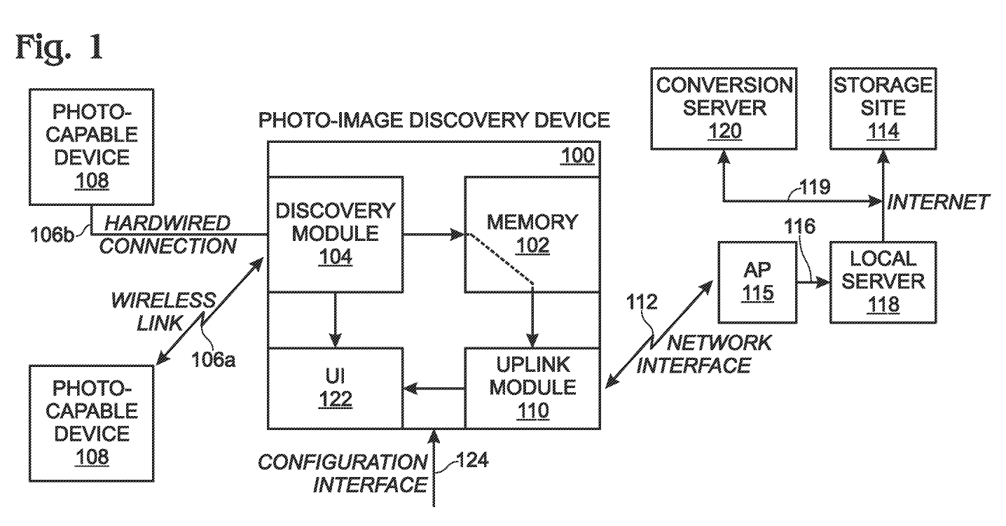

FIG. 1 is a schematic block diagram of a photo-image discovery device. The photo-image discovery device 100 comprises a memory 102 and a discovery module 104 having a scanning interface on line 106 for detecting photo-capable devices. In one aspect, the discovery module scanning interface concurrently scans wireless and hardwired connector interfaces. The wireless interface is represented by reference designator 106a and the hardwire connector interface by reference designator 106b. For simplicity, only a single wireless and single hardwired interface are shown. However, it should be understood that multiple such interfaces may be required for different protocols, frequencies, and connector types.

Some examples of the wireless interface 106a include Bluetooth, wireless USB, and IEEE 802.11 (WiFi) interfaces. However, the device 100 is not limited to just these examples. Some examples of hardwire connector interface 106b include Universal Serial Bus (USB) and SD memory card interfaces. Some examples of photo-image file types include JPEG, GIF, EXIF, native format, BMP, CR2, RAW, and MPEG. Again, the system is not limited to just these exemplary file types and interfaces.

The discovery module 104 determines if detected photo-capable devices 108 have stored electronically formatted photo-images, and if so, acquires the photo-images into the memory 102. If the detected photo-images have been previously acquired into the memory, the photo-images are not reacquired. Some examples of photo-capable devices include a cellular telephone, 3G cell phone, a personal computer (PC), controlled automation device, digital video disk (DVD) device, camera-enabled wireless device, video-enabled wireless device, television, digital video recorder (DVR), secure digital (SD) memory card, digital camera, and game console. Some examples of a controlled automation device include home camera security system and a remotely programmable DVR. In one aspect, the discovery module 104 acquires photo-images from only preconfigured photo-capable devices 108. That is, the discovery module 104 will only acquire photo-images from a limited group of devices with which it has been given permission to act. In this manner, the photo-image discovery device will not “accidentally” acquire images from unauthorized sources. The photo-image discovery device enters photo-capable device configuration commands via a built-in user interface (UI) 122, or via a configuration interface 124, as explained in more detail below.

An uplink module 110 has a network interface on line 112; The uplink module 110 automatically uploads the photo-images in the memory 102 to a network-connected storage site 114. Although only a single storage site is shown for simplicity, it should be understood that the photo-image discovery device is able to communicate with any number of storage sites. The photo-image discovery device may send the same photo-images to more than one storage site. As used herein, a storage site may be a commercial site for printing or archiving photo-images, a site for sharing or publishing photo-images, such as YouTube, or even a local storage site. As another example, a user may be able to monitor their home security system via images sent to a “public” site such as YouTube. As another example, the discovery device may acquire a movie from a device such as a PC, and store the movie in a local memory site.

In one aspect, the uplink module 110 uploads photo-images via a WiFi interface to a network-connected server 114. As shown, a WiFi access point (AP) 115 wirelessly receives information from the photo-image discovery device, transfers the information via a landline 116 to a local server 118, which then uses an Internet protocol to transfer the information to storage server 114 via line 119. However, it would be possible to upload photo-images using other nodes or other protocols to reach the storage site.

Typically, the discovery module 104 acquires and stores the photo-images into memory in the first format, and the uplink module 110 uploads the acquired photo-image in the first format. In one aspect, the discovery module uploads photo-images in a first format (e.g., JPEG) and converts the photo-images to a second format (e.g., GIF). Then, the uplink module 110 uploads photo-images in the second format to the storage site 114. Alternately, the discovery module 104 acquires photo-images in a first format and the uplink module 110 uploads the photo-images to a network-connected conversion device 120 for conversion into a second format. In one aspect, the converted photo-images are returned to the photo-discovery device 100 for uplink to the storage site 114. Alternately, the conversion device transfers the converted photo-images to the storage site directly, via line 119.

In a different aspect, the photo-images may be uploaded and downloaded in the same file format, but can have image attributes changed such as the resolution, compression ratio, red-eye removal. The attributes changed would be dependent upon the attribute parameters associated with the storage device or destination.

In another aspect, the uplink module 110 has an interface for receiving storage site selection commands and transfers the photo-images to at least one selected storage site. The commands may be entered via a built-in user interface (UI) 122, or communicated via a configuration interface 124, as explained in more detail below. The uplink module 110 may determine a photo-image format associated with the selected storage and direct the discovery module or conversion site to convert acquired photo-images to the format associated with the selected storage device.

In one aspect, the UI 122 receives a signal from the uplink module 110 subsequent to uploading the photo-images to the storage site, indicating that the photo-images have been successfully uploaded. In turn, the UI 122 supplies an indication to the user of a successful upload. Likewise, in the event of a failure to upload the photo-images to the storage site, the uplink module 110 may supply a signal to the UI, and the UI supply a prompt to the user, indicating that the photo-images have not been successfully uploaded.

For example, the UI may be a light emitting diode (LED), or a set of LEDs, where LED groups, LED flash patterns, or LED colors signify different events. In another aspect, the UI 122 may incorporate a visual display, such as a liquid crystal display (LCD). Further, the UI 122 may incorporate buttons, switches, a keypad, or a mouse to accept user commands. In one aspect, the discovery module 104 automatically acquires photo-images from devices. However, in another aspect the discovery module only acquires photo-images in response to a UI prompt. That is, the UI 122 indicates that photo-images are available for acquisition, and the user must affirmatively authorize acquisition using a UI button, switch, or the like.

In a similar manner, if the discovery module 104 fails to acquire the photo-images into the memory, it supplies a signal to the UI indicating that the photo-images have not been successfully acquired. In turn, the UI 122 supplies some kind of indicator to the user. Likewise, if the discovery module 104 successfully acquires the photo-images into the memory, it supplies a signal to the UI 122, and the UI 122 supplies an appropriate indicator to the user.

The discovery module 104 may also organize acquired photo-images into folders using criteria such as user, the photo-image discovery device ID, file types, or the photo-capable device originating the photo-images, to name a few examples. The folders may be established in memory 102. Alternately, instructions may accompany the uplinked photo-images, so that folders are created at the storage site 114, and the photo-images stored Un the corresponding folder types.

It is difficult for a user to remember the circumstances associated with each of their photos. This problem is compounded when the user is faced with the daunting task of remembering, sorting, and organizing photos on a camera memory card filled with hundreds of pictures. Conventional processes that simply move the photos from one storage site (i.e. the memory card) to a second storage site (i.e. a PC or network-connected storage site) do not adequately address this problem.

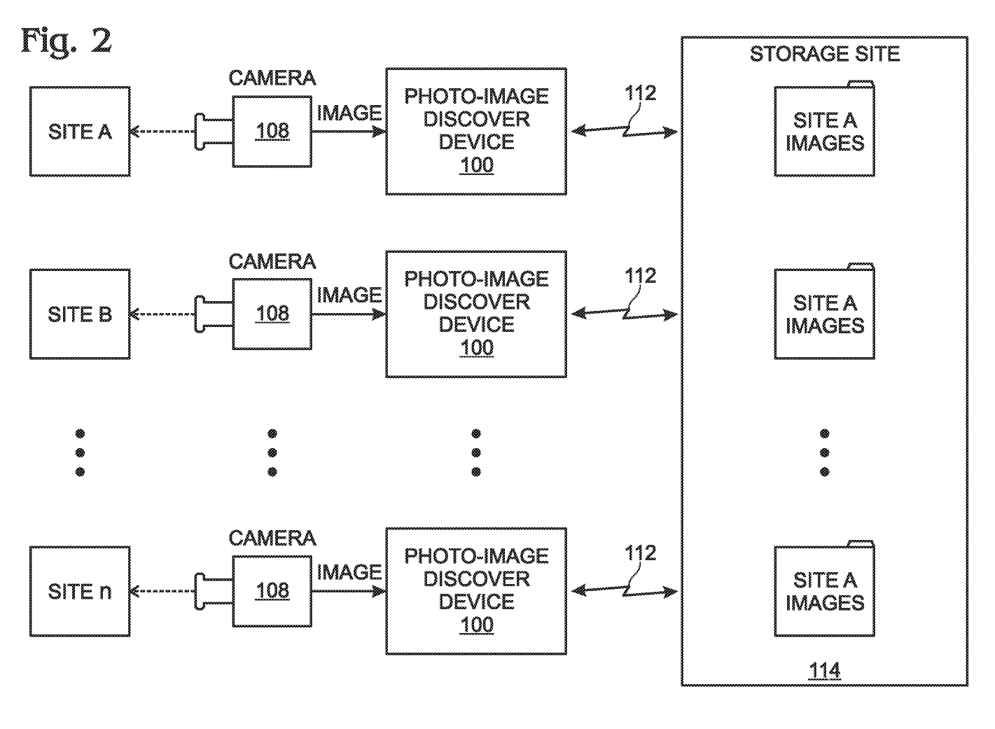

FIG. 2 is a diagram depicting a first exemplary image organization transaction. The photo-image discovery device disclosed herein advantageously acts as an intermediary between images stored on a camera device and storage, giving the user the opportunity to organize images. Some of this organization is performed using the mechanisms already described above. For example, the photo-image discovery device may be preconfigured to separate the images associated with each acquisition/upload operation into a separate folder. If the user is a tourist in Rome, they may choose to manually acquire/upload images after each attraction (sites A through n) they visit. In that manner, the photos associated with each attraction are automatically organized into separate folders at the storage site.

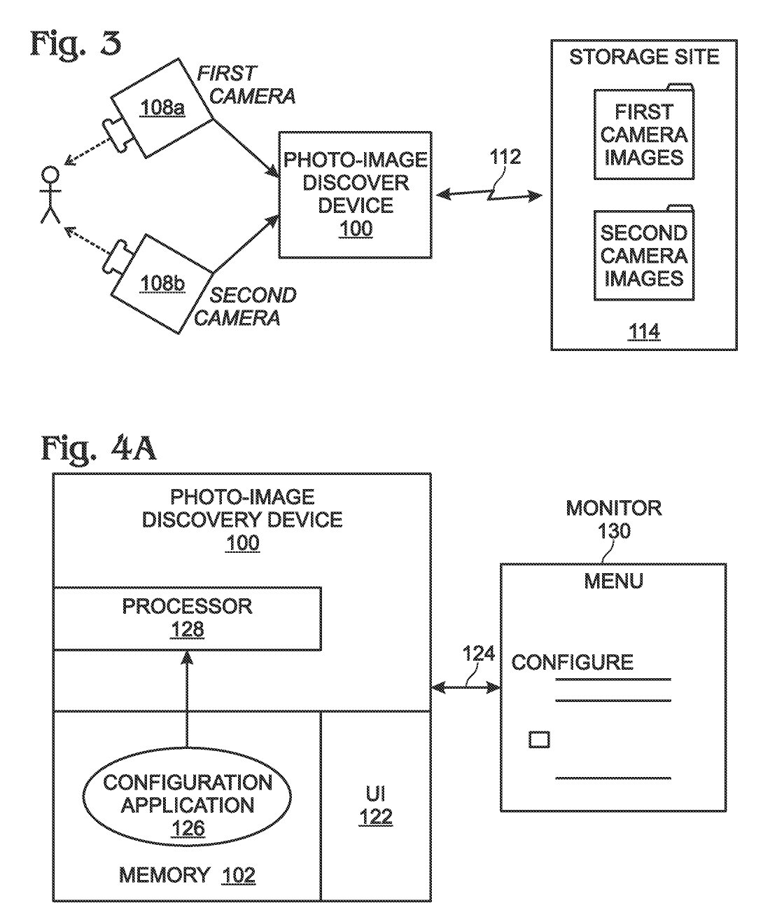

FIG. 3 is a diagram depicting a second exemplary image organization transaction. As another example, the photo-image discovery device may be configured to acquire images from two cameras. If there is a different user associated with each camera, the photo-image discovery device automatically insures that the acquired/uplinked photo-images are being saved in different folders differentiated by user (camera).

More complicated organizational schemes may be pre-configured or implement on-the-fly if the UI 122 is sophisticated enough. Alternately, if the UI 122 is simple (i.e. a set of LEDs), the configuration interface 124 may be used to enter commands.

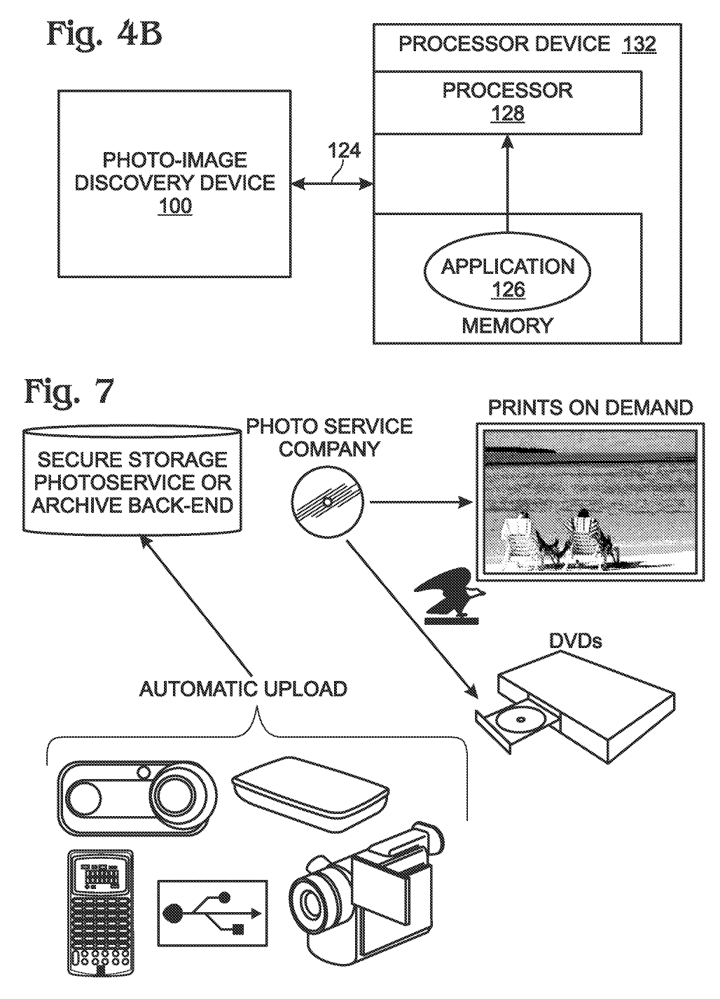

FIGS. 4A and 4B depict two exemplary processes for configuring the photo-image discovery device of FIG. 1. Generally, as shown in FIG. 4A, the configuration interface is wirelessly or hardwire connected to a simple monitor 130, such as a television screen. A configuration software application 126 is stored in memory 102 and enabled as processor instructions. The instructions are executed by processor 128. By executing instructions in the configuration application, the photo-image discovery device is able to generate a menu of instruction prompts and menu options on monitor 130. The user is able to navigate through the menu of prompts and options using the UI 122 (e.g., buttons or keypad). In one aspect, the photo-image discovery device is able to make selections as a wireless point-and-click device.

In another variation (FIG. 4B), the configuration software application 126 resides in a microprocessor device 132 such as a PC or cell phone. Changes and modifications to the photo-image discovery device are made by running the configuration application on the PC. Then, the changes can be loaded into the photo-image discovery device via the configuration interface 124.

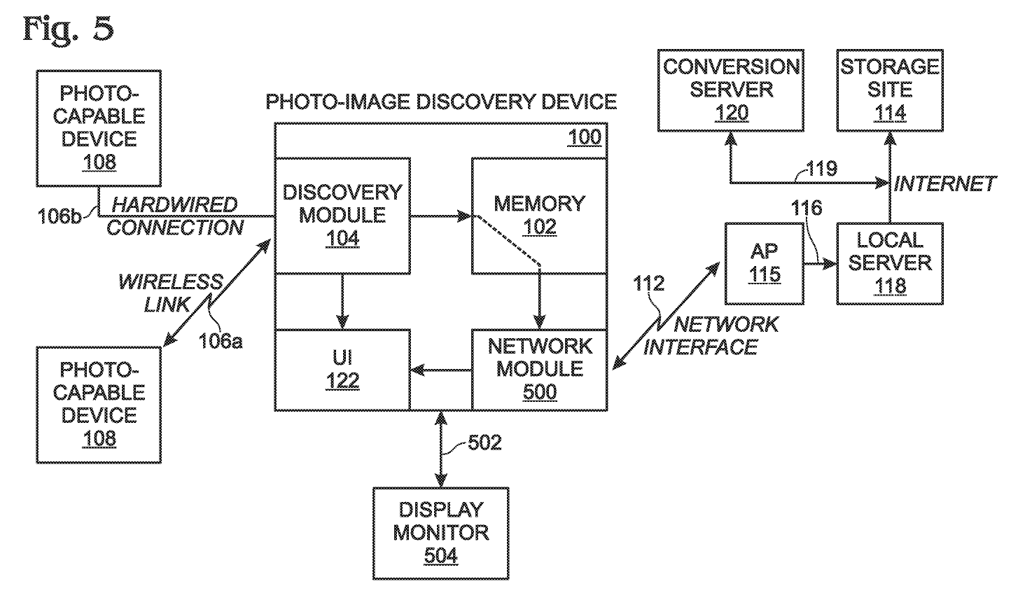

FIG. 5 is a schematic block diagram of a virtual photo-image reproduction kiosk. The virtual kiosk comprises a photo discovery device 100. In one aspect, the photo discovery device may include a few switches and LED indicators, but the photo discovery 100 device has no dedicated display. The photo discovery device 100 includes a network module 500 for automatically uplinking photo-images to a network-connected storage site. This uplink function has been described above in the explanation of the uplink module. However, since the functions of the uplink module are expanded in this aspect, it is referred to as a network module in FIG. 5.

The network module 500 accesses the storage site 114 and downloads selected photo-images. Typically, the network module 500 uplinks and downloads photo-images from the storage site 114 using an IEEE 802.11 (WiFi) link. However, it would be possible to use other wireless formats. In a different aspect, the network module 500 receives a selected photo-image in a first photo-image file format (e.g. JPEG) and the UI module 122 converts the first photo-image file format to a second file image format (e.g., TIFF).

The user interface (UI) module 122 has an interface on line 502 for connection to a display monitor 504. The UI module 122 interfaces the photo discovery device to the display monitor 504 using an interface such as USB, high-definition multimedia interface (HDMI), or wireless. The display monitor 504 may be a television, PC, electronic picture frame, gaming platform, or cell phone to name a few examples. Some examples of wireless interfaces include Bluetooth and WiFi. The display monitor 504 is used to visually, and sometimes audibly, present a menu of photo-image user prompt options. The prompt options are used to select stored photo-images in response to the network module 500 accessing the storage site 114.

Generally, the network module 500 sends an inquiry to the storage site 114 requesting an inventory of stored photo-images and receives the inventory results. The UI module 114 presents the inventory results on the display monitor 504. In one aspect, the network module 500 accesses a storage site including a plurality of photo-image folders. The UI module 122 presents the folders on the display monitor 504, and provides prompts for selecting a folder. Some examples of folders are presented in the explanation of FIGS. 2 and 3. However, there are a number of ways of organizing photo-images into folders.

Subsequent to receiving the selected photo-images, the UI module 122 may receive prompts for transforming selected photo-image attributes. Some examples of image transformations include resizing, zooming, placement, cropping, rotation, resolution, compression, color editing, lightness editing, and red-eye removal. However, this is not an exhaustive list of every possible transformation. The UI module 122 can also be used to present a source profile menu for options on the display monitor 504. Some examples of sources include the photo-capable devices originating the photo-images that are uplinked to the storage site, and file formats.

In another aspect, the UI module 122 can be used to select delivery options for selected photo-images. That is, the network module 500 uplinks photo-images to the storage site 144 and accesses the storage site in response to prompts received by the UI module 122, and the UI module receives prompts for selecting a delivery option from a retailer associated with the first storage site. Then, the network module 500 sends selected delivery options to the storage site. More precisely, the UI module 122 receives input from a user operating the photo discovery device, and sends selection commands in response to the user input. For example, the UI module 122 may receive prompts for selecting a delivery media option such as printed media, DVD, video tape, or SD memory card.

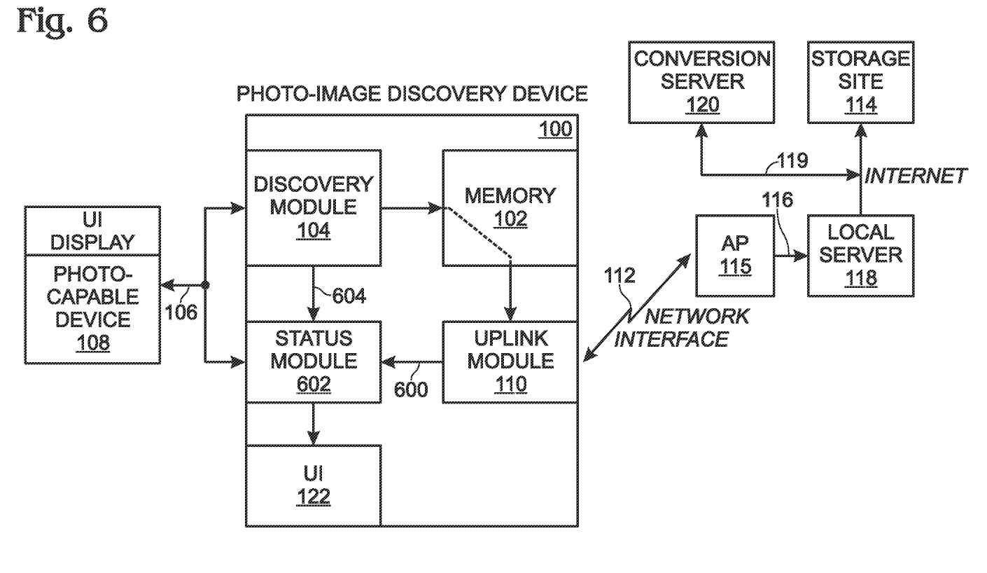

FIG. 6 is a schematic block diagram depicting a system for automatic photo-image uplink confirmation in a photo-image discovery device. The device 100 comprises a memory 102 and a discovery module 104 having a scanning interface 106 for detecting photo-capable devices 108. The discovery module 104 determines if detected photo-capable devices 108 have stored electronically formatted photo-images, and acquires the photo-images into the memory 102. A network module 500 has a network interface 112 for uploading the photo-images in the memory to a network-connected storage site 114, and a status interface on line 600 for supplying upload status information. A status module 602 has an interface on line 600 to receive the upload status information, and an interface on line 106 that is connected to the photo-capable device sourcing the photo-images, to automatically supply a log chronicling photo-image upload status. Alternately, the log is supplied to UI 122, which may display the log via an LED display or speaker, for example.

If the log is sent to the photo-capable device, the status module 602 may supply the log in a photo-image file format for display on a user interface display of the photo-capable device. In one aspect, the status module 602 generates the log in a first file format (e.g., a text-based format) and converts the first file format to the photo-image format (e.g., JPEG). In another aspect, the status module 602 determines the photo-image file format of the acquired photo-images and converts the first file format to the determined photo-images. Thus, if the photo discovery device acquired GIF type photo-images from a camera 108, it would supply the log in the GIF format. For example, the status module 602 may supply the log in one of the following photo-image file formats, which are commonly associated with image storage: JPEG, GIF, EXIF, native format, BMP, CR2, RAW, and MPEG. However, the log is not limited to just these examples. Neither is the log limited to only a photo-image file format. Other formats may include ASCII, TXT, PDF, and configuration files from game consoles.

The status module 602 generates a log chronicling upload status information such as upload complete (all the acquired photo-images were uploaded), no uplink connection, or uplink connection lost a first plurality of times (e.g., the photo discovery device attempted to find a WiFi uplink 5 times). The log can also record events such as photo-images rejected, file formats rejected (the photo-images are in the wrong format of the user does not have an account at the storage site), photo-image file format converted, image transformation operations, the file format types uploaded, the number of photo-images uploaded, authentification requirements (if any), and storage site unavailable. In one aspect, the status module 602 generates a log including a history of upload operations. Generally, the status module is able to log any type of activity that occurs (or doesn't occur) in the uplinking process, and the above list of examples is not intended to be exhaustive.

In another aspect, the discovery module 104 has an interface on line 604 to supply photo-image acquisition information. The status module 602 receives the photo-image acquisition information, and supplies an acquisition report to the photo-image capable device sourcing the photo-images on line 106, chronicling the photo-image acquisition status. The status module 602 supplies the acquisition report in a photo-image file format for display of a user interface display of the photo-capable device 108. Again, the status module 602 may generate the acquisition report in a first file format, determine the photo-image file format of the acquired photo-images, and convert the first file format to the determined photo-images. Alternately, the acquisition report may be presented via the UI 122 of the discovery device 100.

In one aspect, the storage site cooperates in the supply of uplink information. That is, the network module 500 may receive uplink confirmation information from the storage site and supply the uplink confirmation information in the upload status information. For example, the storage site may download information about the number of photo-images received or account management information. Then, the status module 602 generates a log including the uplink confirmation information.

The various components and modules of the photo discovery device may be enabled using state machine and combinational logic circuitry. Alternately, the device modules may be enabled using a software application of instructions that are stored in memory and executed by a processor. A photo discovery device processor with a configuration software application stored in memory is shown in FIG. 4A. Other applications in memory may include the portion of the discovery, status, UI, and network modules.

### FUNCTIONAL DESCRIPTION

Conventionally, a user must perform many steps to store their pictures into a website for sharing, printing, or archiving. Further, a large proportion of these users either do not own a PC, or they are uncomfortable using a PC. These users would like to store, edit, print, and archive their pictures and video clips without having to go thru an intermediate step requiring the use of a PC.

To that end, the photo-image discovery device described in FIG. 1 automates the upload of files from devices such as a digital camera, 3G phones, and cell phone to a backend service by reducing/eliminating the user intervention. Reduced user intervention accelerates the availability of photo-images for sharing, viewing, protecting, and printing. Unlike conventional automatic acquisition technology, the photo-image discovery device disclosed herein is not limited to a single kind of image media, single image source, or single image destination.

The system described in FIG. 5 permits any monitor, including a TV screen, PC monitor, or digital picture frame to become a virtual kiosk for organizing pictures in a repository website or back end photo service center. The kiosk can be used to order prints and arrange delivery of those prints. The kiosk provides a home shopping experience without the bother of using a PC.

FIG. 7 is a diagram depicting the photo-image discovery device from a functional perspective. In one aspect, a digital camera or SD memory card is connected to the photo-image discovery device using a USB cable. The photo-image discovery device automatically transfers pictures, video clips, files to its memory/storage and asynchronously starts to upload those files, thru WiFi, to an archive backend service or picture website.

From a cell phone, a Bluetooth connection may be established (pairing), and images acquired from the cell phone through the Bluetooth connection are uploaded to the backend service or the picture website. From a 3G phone, a WiFi connection is established with the photo-image discovery device and WiFi link is used to acquire pictures and video clips. A second WiFi link is used to transfer images from the photo-image discovery device to the backend service or picture website.

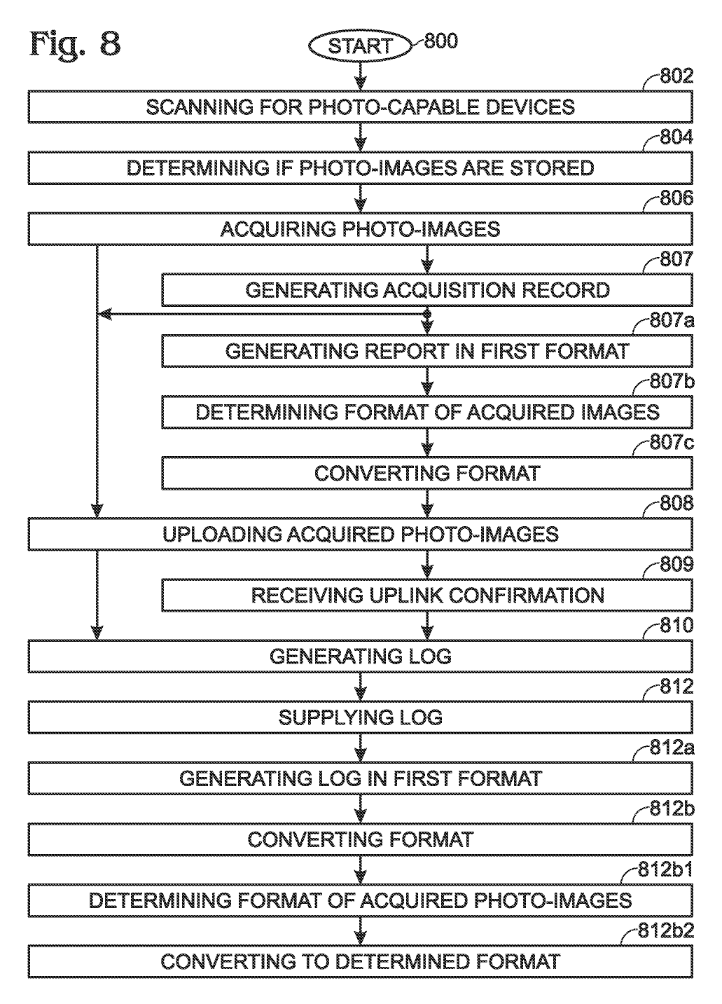

FIG. 8 is a flowchart illustrating a method for automatic photo-image uplink confirmation. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method starts at Step 800.

In Step 802 a photo-image discovery device scans communication interfaces for photo-capable devices. Step 804 determines if detected photo-capable devices have stored electronically formatted photo-images. Step 806 acquires the photo-images into the photo-image discovery device. Step 808 uploads the acquired photo-images to a network-connected storage site. Step 810 generates a log chronicling the photo-image upload status. Step 812 automatically supplies the log to the photo-capable device sourcing the photo-images. Alternately, the log is supplied via a discovery device user interface. In one aspect, the photo discovery device indicates that the log is available, and the user supplies a prompt requesting the log. That is, the log is not supplied until the user requests the log.

In one aspect, automatically supplying the log in Step 812 includes supplying the log in a photo-image file format for display on a user interface display of the photo-capable device. In another aspect, automatically supplying the log includes substeps. Step 812a generates the log in a first file format, and Step 812b converts the first file format to the photo-image format. Further, the step of converting the first file format to the photo-image format may include substeps. Step 812b1 determines the photo-image file format of the acquired photo-images, and Step 812b2 converts the first file format to the determined photo-images. The log may be supplied in one of the following photo-image file formats: JPEG, GIF, EXIF, native format, BMP, CR2, RAW, and MPEG. Other formats include ASCII, TXT, PDF, and game console configuration files.

Generating the log chronicling the photo-image upload status (Step 810) may includes chronicling upload status information such as upload complete, no uplink connection, uplink connection lost a first plurality of times, photo-images rejected, file formats rejected, photo-image file format converted, image transformation operations, file format types uploaded, the number of photo-images uploaded, authentification requirements, and storage site unavailable. Step 810 may also generate a log including a history of upload operations.

In one aspect, Step 807 automatically supplies an acquisition report from the photo discovery device to the photo-image capable device sourcing the photo-images, chronicling the photo-image acquisition status. Alternately, the acquisition report is supplied via a user interface of the discovery device. Again, the report can also be supplied in response to a user request instead of automatically. The report is supplied in a photo-image file format for display on the user interface display of the photo-capable device. The supplying of the report in a photo-image file format may include substeps. Step 807a generates the report in a first file format. Step 807b determines the photo-image file format of the acquired photo-images. Step 807c converts the first file format to the determined photo-images.

In a different aspect, Step 809 receives uplink confirmation information from the storage site, and generating the log chronicling the photo-image upload status in Step 812 includes generating a log including the uplink confirmation information.

A system and method have been provided for automatic photo-image uplink confirmation. Examples of specific processes and hardware modules have been given to illustrate the invention. However, the invention is not limited to merely these examples. Other variations and embodiments of the invention will occur to those skilled in the art.

We claim:

1. A method for automatic photo-image uplink confirmation, the method comprising:
a photo-image discovery device scanning communication interfaces for photo-capable devices;
determining if detected photo-capable devices have stored electronically formatted photo-images;
acquiring the photo-images into the photo-image discovery device;
uploading the acquired photo-images to a network-connected storage site;
generating a log chronicling the photo-image upload status; and,
automatically supplying the log via an interface selected from a group consisting of a photo-image discovery device user interface and a photo-capable device user interface.

2. The method of claim 1 wherein automatically supplying the log includes supplying the log in a photo-image file format for display on a user interface display of the photo-capable device.

3. The method of claim 2 wherein automatically supplying the log includes:
generating the log in a first file format; and,
converting the first file format to the photo-image format.

4. The method of claim 3 wherein converting the first file format to the photo-image format includes:
determining the photo-image file format of the acquired photo-images; and,
converting the first file format to the determined photo-images.

5. The method of claim 1 wherein generating the log chronicling the photo-image upload status includes chronicling upload status information selected from a group consisting of upload complete, no uplink connection, uplink connection lost a first plurality of times, photo-images rejected, photo-image file format converted, file formats rejected, image transformation operations, file format types uploaded, the number of photo-images uploaded, authentification requirements, and storage site unavailable.

6. The method of claim 2 wherein supplying the log in the photo-image file format for display of a user interface display of the photo-capable device includes supplying the log in a photo-image file format selected from a group consisting of JPEG, GIF, EXIF, native format, BMP, CR2, RAW, MPEG, ASCII, TXT, PDF, and game console configuration files.

7. The method of claim 1 further comprising:
automatically supplying an acquisition report via an interface selected from a group consisting of a photo-image discovery device user interface and a photo-capable device user interface, chronicling the photo-image acquisition status.

8. The method of claim 7 wherein supplying the acquisition report includes supplying the report in a photo-image format for display on a user interface of the photo-capable device.

9. The method of claim 8 wherein supplying the report in a photo-image file format for display on the user interface display of the photo-capable device includes:
generating the report in a first file format;
determining the photo-image file format of the acquired photo-images; and,
converting the first file format to the determined photo-images.

10. The method of claim 1 wherein generating the log chronicling the photo-image upload status includes generating a log including a history of upload operations.

11. The method of claim 1 further comprising:
receiving uplink confirmation information from the storage site; and,
wherein generating the log chronicling the photo-image upload status includes generating a log including the uplink confirmation information.

12. In a photo-image discovery device, a system for automatic photo-image uplink confirmation, the device comprising:
a memory;
a discovery module having a scanning interface for detecting photo-capable devices, the discovery module determining if detected photo-capable devices have stored electronically formatted photo-images, and acquiring the photo-images into the memory;
a network module having a network interface for uploading the photo-images in the memory to a network-connected storage site, and a status interface for supplying upload status information; and,
a status module having an interface to receive the upload status information, and an interface selected from a group consisting of a user interface of the photo-capable device sourcing the photo-images and a user interface of the photo-image discovery device, to automatically supply a log chronicling photo-image upload status.

13. The device of claim 12 wherein the status module supplies the log in a photo-image file format for display on a user interface display of the photo-capable device.

14. The device of claim 12 wherein the status module generates the log in a first file format and converts the first file format to the photo-image format.

15. The device of claim 14 wherein the status module determines the photo-image file format of the acquired photo-images and converts the first file format to the determined photo-images.

16. The device of claim 12 wherein the status module generates a log chronicling upload status information selected from a group consisting of upload complete, no uplink connection, uplink connection lost a first plurality of times, photo-images rejected, file formats rejected, photo-image file format converted, image transformation operations, file format types uploaded, the number of photo-images uploaded, authentification requirements, and storage site unavailable.

17. The device of claim 13 wherein the status module supplies the log in a photo-image file format selected from a group consisting of JPEG, GIF, EXIF, native format, BMP, CR2, RAW, MPEG, ASCII, TXT, PDF, and game console configuration files.

18. The device of claim 12 wherein the discovery module has an interface to supply photo-image acquisition information; and, wherein the status module has an interface to receive the photo-image acquisition information, the status module supplying an acquisition report via an interface selected from a group consisting of a photo-image discovery device user interface and a photo-capable device user interface, chronicling the photo-image acquisition status.

19. The device of claim 18 wherein the status module supplies the acquisition report in a photo-image file format for display of a user interface display of the photo-capable device.

20. The device of claim 19 wherein the status module generates the acquisition report in a first file format, determines the photo-image file format of the acquired photo-images, and converts the first file format to the determined photo-images.

21. The device of claim 12 wherein the status module generates a log including a history of upload operations.

22. The device of claim 12 wherein the network module receives uplink confirmation information from the storage site and supplies the uplink confirmation information in the upload status information; and,
wherein the status module generates a log including the uplink confirmation information.
